(19) United States
(12) Patent Application Publication
(10) Pub. No.: US 2006/0001770 A1
(43) Pub. Date: Jan. 5, 2006

(54) Vehicle remote controller with a built-in digital camera

(76) Inventor: Sae Byul Kang, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/024,839

(22) Filed: Dec. 28, 2004

(30) Foreign Application Priority Data
Jul. 5, 2004 (KR) 2004-51871

(51) Int. Cl. H04N 11/00; G08C 19/00

(52) U.S. Cl. 348/552; 340/825.72

(57) ABSTRACT

The present invention relates to a remote controller of a vehicle with a built-in digital camera. The remote controller of the present invention is provided with a built-in digital camera so that it can be used to record the actual scenes of a car accident as images. The built-in digital camera in the remote controller of the present invention comprises a base plate, which comprises a liquid crystal display, a shutter, a lens, a control unit, a memory unit, and an input/output port.

### CROSS REFERENCE TO RELATED APPLICATION

This application claims priority from Korean Patent Application No. 2004-51871, filed on Jul. 5, 2004, which is hereby incorporated by reference in its entirety.

### FIELD OF THE INVENTION

The present invention relates to a vehicle remote controller with a built-in digital camera. More particularly, this invention relates to a vehicle remote controller with a built-in digital camera, which can be used to record the scenes of car accidents as images.

### BACKGROUND OF THE INVENTION

Vehicle accidents are no longer rare incidents to be observed in our daily lives, and they often result in having disputes between people being involved in the accidents because of the difficulties of retaining the actual spot of the accident which may help to distinguish between right and wrong. Therefore, some drivers carry cameras including Polaroid cameras in the glove box of their cars as a way to obtain a solid on-the-spot evidence in case of an accident. However, for people who normally do not carry cameras, they are at risk in becoming innocent victims. Therefore, there has been a long-felt need for drivers to have a reliable means to preserve the accident scene as it is.

### SUMMARY OF THE INVENTION

The present invention provides a vehicle remote controller with a built-in digital camera to record the actual scenes from a car accident as images, while it can be still used under normal situations for remote start-up or locking/unlocking of a car door from a distance. The images recorded by the digital camera can be very helpful for use as evidence covering on-the-spot scenes.

### BRIEF DESCRIPTION OF THE DRAWINGS

The aforementioned aspect and other features of the present invention will be explained in the following detailed description, taken in conjunction with the accompanying drawings, wherein:

FIG. 1 is a perspective view of a remote controller with a built-in digital camera according to an embodiment of the present invention;

FIG. 2 is a front view of a remote controller with a built-in digital camera according to an embodiment of the present invention;

FIG. 3 is a rear view of a remote controller with a built-in digital camera according to an embodiment of the present invention; and

FIG. 4 is a side view of a remote controller with a built-in digital camera according to an embodiment of the present invention.

### DETAILED DESCRIPTION OF THE INVENTION

The present invention provides a vehicle remote controller with a built-in digital camera, wherein the digital camera comprising:

(a) a base plate which comprises a liquid crystal display, a shutter, a lens, a control unit, and a memory; and

(b) an input/output port,

wherein the digital camera is arranged in a preset manner both inside and outside of the case of the remote controller.

In a preferred embodiment of the present invention, the shutter in the remote controller is disposed at an upper front end along with the door locking and unlocking buttons while the liquid crystal display is disposed at a lower front end of the remote controller case.

In a more preferred embodiment of the present invention, the lens is disposed at an upper rear end of the remote controller case while the input/output port is mounted at one end of the remote controller case.

In another preferred embodiment of the present invention, the remote controller case is further provided with an on/off switch for a digital camera in a preset position.

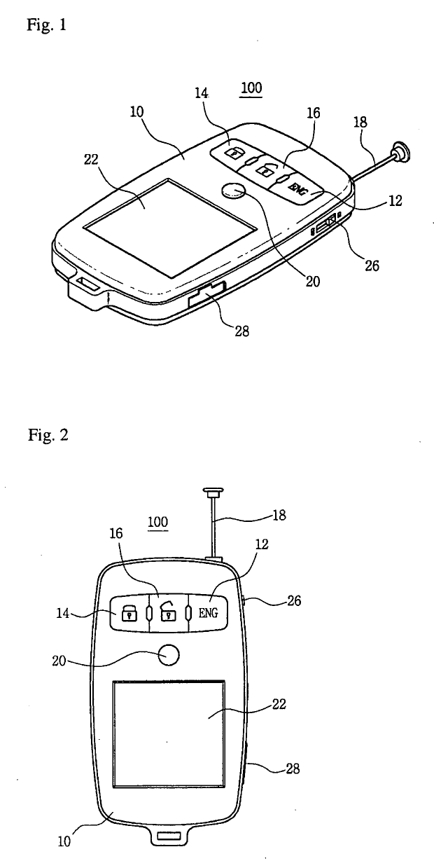

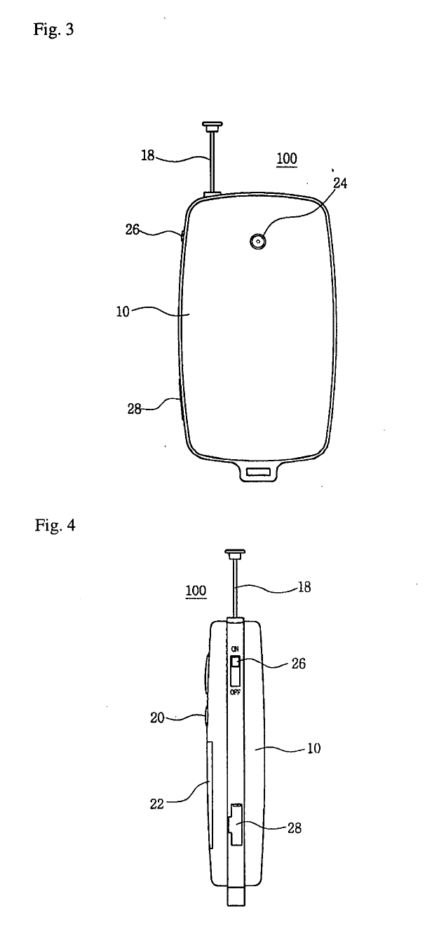

The present invention is described in greater detail with reference to the accompanying drawings, but they should not be construed as limiting the scope of this invention. FIG. 1 shows a perspective view of a remote controller with a built-in digital camera according to an embodiment of the present invention. FIG. 2 is a front view of the same. FIG. 3 is a rear view of the same.

The present invention is particularly advantageous in that a built-in digital camera is provided in a vehicle remote controller so that on-the-spot scenes of any unexpected vehicle accidents can be recorded as images in the event of such accidents, and they can be used as evidence to resolve disputes that may result from the accidents.

Generally, a vehicle remote controller is provided with a button for engine start-up 12 and buttons for door locking and unlocking 14 and 16, respectively, along with an antenna 18 disposed at an upper front end to exchange signals for a remotely controlled engine start-up. In recent years, mobile phones have been provided with built-in cameras, and, in this invention, each component of the digital camera is disposed in a preset manner of arrangement.

As stated above, the above digital camera comprises a base plate which comprises a liquid crystal display, a shutter, a lens, a control unit, a memory unit, and an input/output port. The digital camera is arranged in a preset manner so that the liquid crystal display, the shutter, the lens, and the input/output port are exposed to the outside while the control unit and memory unit are disposed inside of the remote controller case. A vehicle remote controller with a built-in digital camera of the present invention can be prepared by disposing each of the digital components both inside and outside of the vehicle remote controller in a preset manner. That is, door locking and unlocking buttons 14 and 16 are disposed at the front side of the case 10 of the remote controller and a shutter 20 is disposed in an area between the above two buttons. Further, the liquid crystal display 22 is disposed at the lower front end of the remote controller case 10, and the lens 24 is disposed at the upper rear end of the remote controller case 10 as shown in FIG. 3.

Additionally, an on/off switch 26 for the digital camera is disposed at a preset position of the remote controller case 10 so that the digital camera can be “on” only when the camera is to perform its presumed function. The input/output port that transmits information obtained as images to other external devices, such as a PC, a camcorder, a printer, etc., is disposed at one end of the remote controller case 10 as shown in FIG. 4. Therefore, the remote controller of the present invention can perform its original functions of engine start-ups and locking/unlocking doors from a distance under normal situations while it can serve an additional important function of taking pictures of on-the-spot car accident scenes and storing them as image files, when needed.

That is, by going through with the simple steps of putting the switch 26 of the digital camera in the “on” position, directing the lens toward the object of the car accident during which the digital camera concurrently takes pictures of the spots of the car accident by pushing the shutter 20 while viewing through the display 22, the images of these pictures can be stored and/or printed by connecting to other external devices such as a PC, a camcorder, a printer, etc., and used as valuable information to settle any related disputes should they ever happen.

While the foregoing description represent various embodiments of the present invention, it will be appreciated that the foregoing description should not be deemed limiting since additions, variations, modifications and substitutions may be made without departing from the spirit and scope of the present invention. It will be clear to one of skill in the art that the present invention may be embodied in other forms, structures, arrangements, and proportions and may use other elements, materials and components. The present disclosed embodiments are, therefore, to be considered in all respects as illustrative and not restrictive, the scope of the invention being indicated by the appended claims and not limited to the foregoing description.

What is claimed is:

1. A remote controller of a vehicle with a built-in digital camera:
(a) a base plate which comprises a liquid crystal display, a shutter, a lens, a control unit, and a memory; and
(b) an input/output port,
wherein a digital camera is arranged in a preset manner both inside and outside of a case for said remote controller.

2. The remote controller according to claim 1, wherein said shutter is disposed at an upper front end of said case for said remote controller along with a door locking button and a unlocking button while said liquid crystal display is disposed at a lower front end of said case for said remote controller.

3. The remote controller of a vehicle with a built-in digital camera according to claim 1, wherein said lens is disposed at an upper rear end of said case for said remote controller and said input/output port is mounted at one end of said case for said remote controller.

4. The remote controller according to claim 1, wherein said case for said remote controller is further provided with an on/off switch of said digital camera in a preset position.

5. A digital camera comprising:
a vehicle remote controller; and
a display, a shutter, and a lens disposed on said vehicle remote controller.

6. The digital camera of claim 5 further comprising a memory disposed within said vehicle remote controller.

7. The digital camera of claim 5 further comprising an activation switch disposed on said vehicle remote controller.

8. The digital camera of claim 5 further comprising an input/output port disposed on said vehicle remote controller.

9. An apparatus for taking pictures, comprising:
a vehicle remote controller; and
a digital camera built into said vehicle remote controller.

10. The apparatus of claim 9, wherein said digital camera comprises a shutter, a lens, a memory, and an input/output port.

11. The apparatus of claim 10, wherein said digital camera comprises a display disposed on said vehicle remote controller.

12. The apparatus of claim 11, wherein said digital camera comprises an activation switch disposed on said vehicle remote controller.
